(19) United States
(12) Patent Application Publication
(10) Pub. No.: US 2021/0162529 A1
(43) Pub. Date: Jun. 3, 2021

(54) DEVICE FOR BLOCKING COOLING WATER OF WELD GUN

(71) Applicant: ATRON INC., Siheung-si, Gyeonggi-do (KR)

(72) Inventor: Jong Chan LIM, Suwon-si, Gyeonggi-do (KR)

(21) Appl. No.: 16/473,702

(22) PCT Filed: Dec. 22, 2017
(86) PCT No.: PCT/KR2017/015305

§ 371 Date: Sep. 6, 2019

(30) Foreign Application Priority Data
Dec. 26, 2016 (KR) 10-2016-0179130

(51) Int. Cl. B23K 11/30; B23K 11/11; B23K 11/31

(52) U.S. Cl. CPC B23K 11/3018; B23K 2101/006; B23K 11/314; B23K 11/11

(57) ABSTRACT

The present invention relates to a device for blocking cooling water of a weld gun, the device preventing water leakage by blocking the cooling water leaking from the weld gun when a tip provided to the weld gun is replaced. The device for blocking the cooling water of the weld gun comprises: a first piston valve (23) connected to a first solenoid valve (17), operated by a signal of a control unit, so as to start operation according to a signal thereof, and receiving the cooling water from a cooling water inlet end; a main supply pipeline (23) of which one side is connected to a cooling water inlet pipe (27) of the weld gun and the other side is connected to an outlet end of the first piston valve (23); a second piston valve (29) operated by a first solenoid valve (15), and provided on a main discharge pipeline (31) so as to cut off the cooling water discharged or allow the same to pass therethrough; a suction means (35) for suctioning the cooling water filled in the pipeline by means of vacuum and holding the same when the weld gun tip is removed such that the pipeline is opened; and a pressure sensor (49) for sensing that the weld gun tip is separated and the pressure of the pipeline instantly drops so as to drive a circuit, thereby sensing an instant change in fluid pressure; and a cleaning means (47) for removing scales and foreign substances accumulated inside the weld gun, using spraying of air pressure.

### TECHNICAL FIELD

The present invention relates to a device for blocking cooling water of a weld gun, and more particularly, to a device for blocking cooling water of a weld gun which prevents leakage of water by blocking cooling water leaked from the weld gun when a tip installed in the weld gun is replaced or the tip is fused and separated during a welding operation.

### BACKGROUND ART

In vehicle body welding lines and the like, robot welders are widely used for spot welding of steel plates or a steel plate and a structural member. Since the robot welder can make various motions according to a program and can perform an operation promptly, it is essential equipment in a vehicle assembly line. A tip is inserted into an end of a welding gun of a robot welder. Since discharging occurs in the tip and is worn according to use thereof, the tip is a consumptive product that has to be replaced periodically.

Cooling water for cooling the heated tip is supplied into the weld gun.

The tip and a finger of the weld gun are coupled in a press-fitting manner to be easily replaced. That is, in the weld gun that is currently used, the outer peripheral surface of the finger of the weld gun and the inner peripheral surface of a tip hole are tapered. Accordingly, if the tip is inserted into the finger of the weld gun by a force, they are coupled to each other strongly, and if the tip is rotated slightly, they are separated from each other.

Since the operation of replacing the tip is not that difficult, it has been conventionally made by a manual operation of the operator. Further, according to occasions, a tip may be exchanged by a mechanical method suggested by the present inventor (see Korean Patent No. 10-1514219).

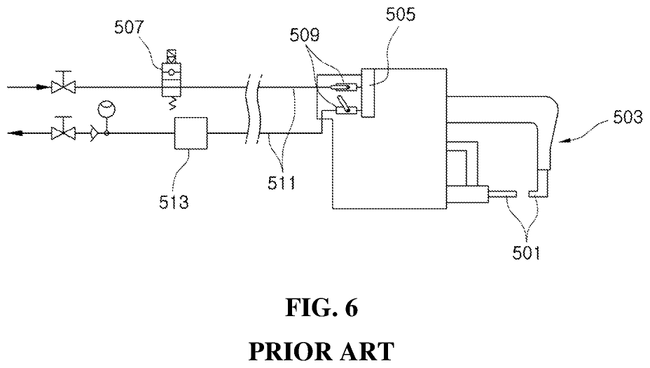

Hereinafter, the conventional technology will be described with reference to FIG. 6.

For cooling water supplied to a weld gun 503 when the operator replaces a tip 501, a ball valve in a manifold 505 has to be blocked in advance. This is because the cooling water of high pressure continues to flow out through an opened end of the weld gun when the tip is replaced. When the weld gun tip 501 is replaced by the mechanical means, an operation of a block valve 507 has to be performed first. However, even when the ball valve 509 is closed or the blocking valve 507 is operated, the cooling water is inevitably discharged to a work place by the pressure left in the interior of a hose 511. Since the amount of the cooling water discharged whenever the tip 501 is replaced one time cannot be neglected (for example, 0.5 liters), the vicinity of the work place is always full of cooling water. The phenomenon causes the inconvenience of the operation, the environmental contamination due to the cooling water containing additives is problematic, and a danger of a safety accident may be caused.

Meanwhile, the tip may be fused during welding to be separated from the weld gun. In this case, a flow switch 513 installed on the bottom of the work place detects a decrease in the amount of the fluid to close a cooling water supply valve. However, while the flow switch 513 detects leakage of water and blocks the pipeline, the high-pressure cooling water contained in the weld gun 503, and a hose 511 having the length of 10 to 15 m located between the blocking valve 507 and the weld gun 503 is poured onto the product and the like. Since the cooling water blocking speed is slow, the corresponding product cannot be protected from the pouring cooling water. Since the cooling water has a substance which accelerates the corrosion rate of the metallic product, the corresponding product has to be discarded or retreated as its product value is severely damaged, which causes a severe economic loss.

### DISCLOSURE

### Technical Problem

An object of the present invention is to provide a device for blocking cooling water of a weld gun, by which cooling water supplied to a weld gun tip is prevented from dropping from the weld gun when the weld gun tip is replaced.

Another object of the present invention is to provide a device for blocking cooling water of a weld gun, by which a product can be protected from cooling water by removing the amount of leaked water even when a weld gun tip is fused to a welded object to be separated from the weld gun instantly.

In more detail, a welding error, and thus a quality error is generated if a pipeline becomes narrower and a cooling error is generated due to foreign substances or scales in the interior of a weld gun, and an object of the present invention is to eliminate severe loss caused even when a welding error is generated at one site of a vehicle welding line for automation. A conventional welding robot line is configured such that a blocking valve, that is, an on/off valve of an imported product is installed on a supply side of cooling water and a check valve is installed on an exhaustion side, and a water pressure is left in a tube pipeline so that the cooling water is inevitably discharged even if the on/off valve is switched off when the tip is replaced, and the amount of discharged cooling water is too large that the device cannot be used when the tip is separated by a mechanical device, and the present invention aims at solving the problems.

### Technical Solution

According to an aspect of the present invention, there is provided

a device for blocking cooling water of a weld gun, the device being installed between a cooling water supply pipeline and the weld gun to prevent cooling water left in the weld gun from dropping when a tip of the weld gun is separated, the device including:

a first piston valve 23 connected to a first solenoid valve 15 operated by a signal of a control unit to be actuated by the signal, the first piston valve 23 being supplied the cooling water from a cooling water inlet end;

a main supply pipeline 23, one end of which is connected to a cooling water inlet pipe 27 and an opposite side of which is connected to an output end of the first piston valve 23;

a second piston valve 29 operated by the first solenoid valve 15, the second piston valve 29 being installed on a main discharge pipeline 31 to block or pass the discharged cooling water;

a suction means 35 for suctioning the cooling water filled on a pipeline through vacuum and holding the cooling water when the tip of the weld gun is removed and the pipeline is opened; and

a pressure sensor 49 or a flow sensor configured to detect a pressure on the pipeline from instantly dropping as the tip of the weld gun is separated to drive a circuit, thereby detecting an instant change of the pressure of a fluid.

According to another aspect of the present invention, the suction means 35 includes:

a second solenoid valve 17 operated by a signal of the pressure sensor 49 or the flow sensor;

an auxiliary tank 37 installed on the main supply pipeline 23 and the main discharge pipeline 31 to suction the cooling water in the weld gun and hold the cooling water;

a third piston valve 39, one side of which is connected to the second solenoid valve 17 and an opposite side of which is connected to the auxiliary tank 37; and

a vacuum unit 41 that actuates the auxiliary tank 37 by selectively generating a positive pressure and a vacuum pressure by the third piston valve 39.

### Advantageous Effects

According to the configuration, if the operator switches on the solenoid valves 15 and 17 simultaneously to replace a welding tip, the supply side and the exhaustion side are closed, and the auxiliary tank maintains a state in which some cooling water is introduced into the auxiliary tank by a vacuum generator 41 and internal water pressures of the cooling water supply pipe line 27 and the discharge pipeline 33 is vacuumed. Then, the cooling water willing to flow down by the self-weight in the interior of the weld gun at the moment at which the tip is separated from the weld gun is suctioned by a vacuum force and is kept in the auxiliary tank 37, and if the first and second solenoid valves 15 and 17 are switched off after a new tip is mounted, the cooling water contained in the auxiliary tank 37 is discharged by the compressed air to circulate again so that the water is prevented from dropping from the weld gun when the tip of the weld gun is replaced.

Accordingly, the cooling water is hardly discharged even when the weld gun tip is replaced by a mechanical method so that the work place can be cleanly maintained and the cooling water may be ejected to the work field when the tip is separated as it is fused during a welding operation, and then, if the first and second solenoid valves 15 and 17 are operated simultaneously by the signal of the flow sensor in the welding robot, the cooling water on the supply side and the cooling water on the exhaustion side can be blocked simultaneously to minimize ejection of the cooling water and the vacuum pressure is operated such that the cooling water left in the pipeline does not flow down and is contained in the auxiliary tank 37 so that a safety accident can be prevented.

Further, since the first and third solenoids 15 and 19 are switched on simultaneously, the cooling water on the supply side is blocked and the cooling water on the exhaustion side is opened, and accordingly, a cooling effect is made to become higher by ejecting the compressed air into the welding pipeline and removing scales stuck to the pipeline to make the flow of the cooling water better so that the quality of the vehicle body can be improved by lowering heat generated during spot welding.

### DESCRIPTION OF THE INVENTION

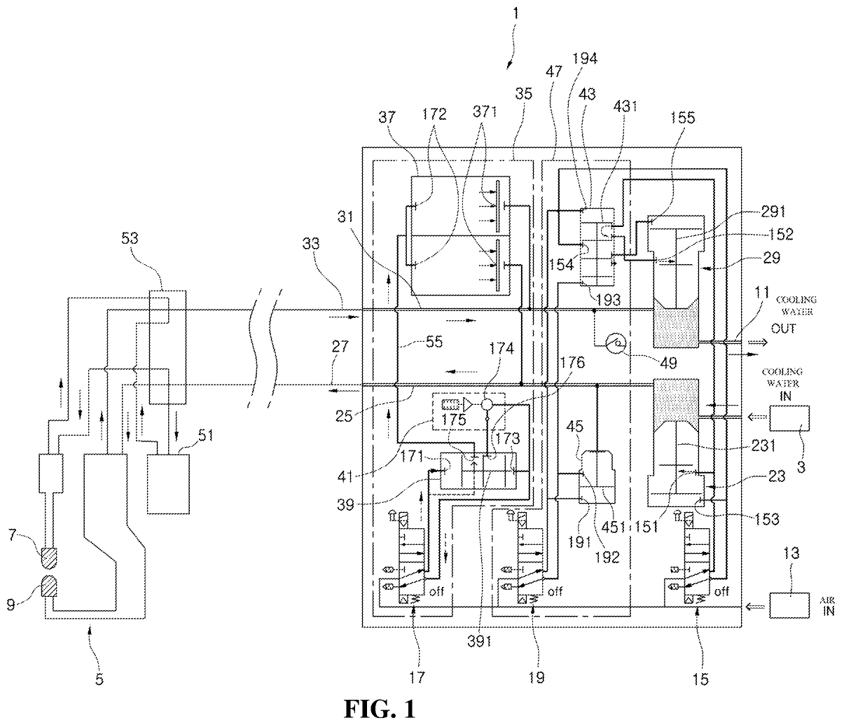

FIG. 1 is a circuit diagram of a device for blocking cooling water of a weld gun according to an embodiment of the present invention, and illustrates a normal operation state.

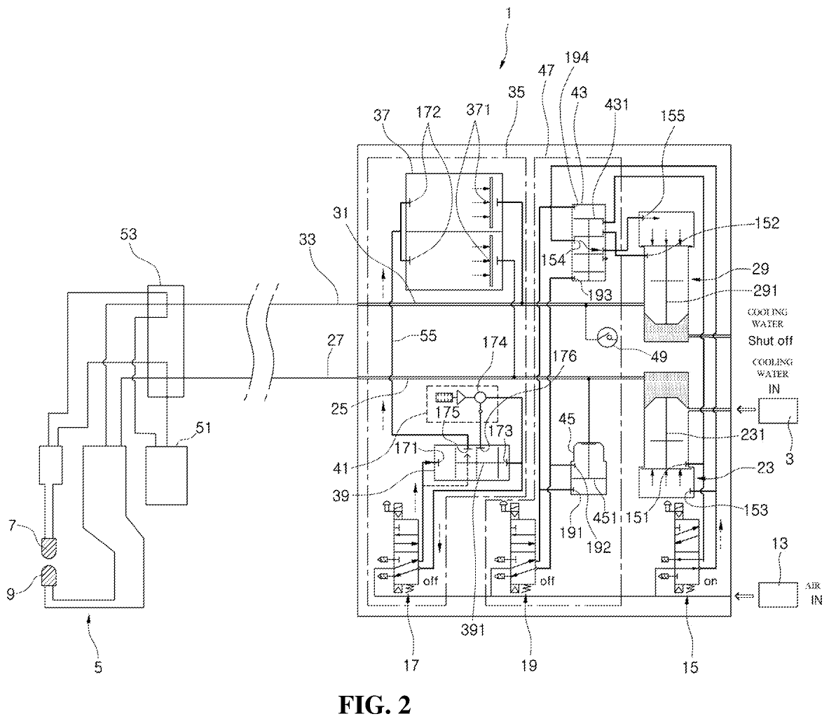

FIG. 2 is a circuit diagram of the device for blocking cooling water of the weld gun according to the embodiment of the present invention, and illustrates a state in which supply of cooling water is blocked.

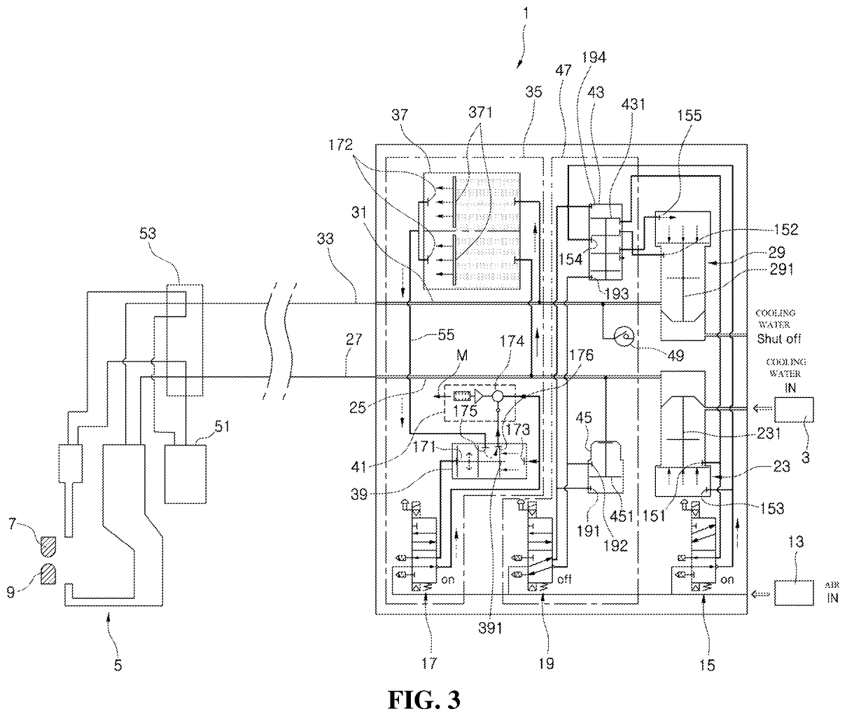

FIG. 3 is a circuit diagram of the device for blocking cooling water of the weld gun according to the embodiment of the present invention, and illustrates a state in which a tip is fused to be separated from the weld gun or replaced.

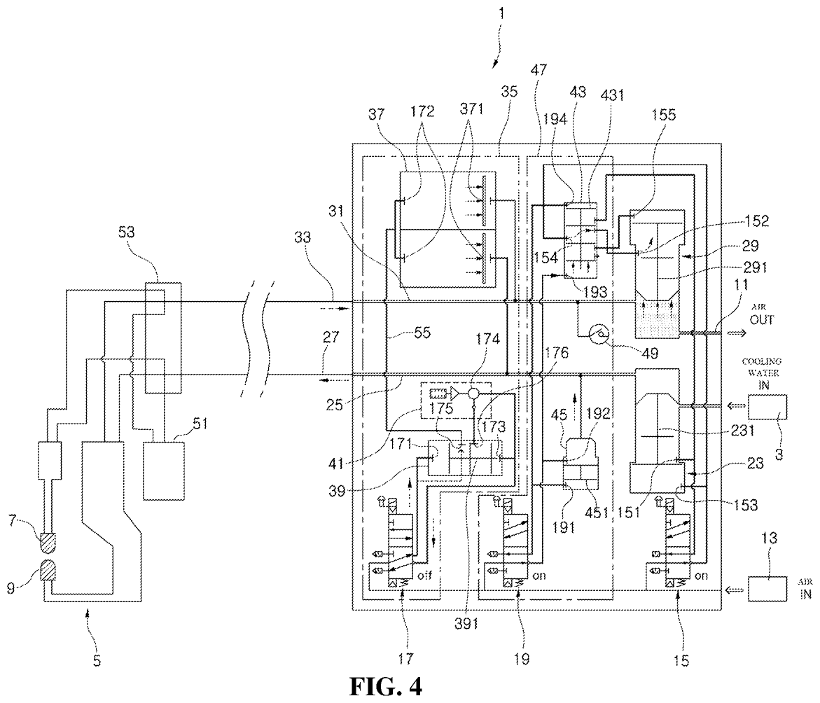

FIG. 4 is a circuit diagram of the device for blocking cooling water of the weld gun according to the embodiment of the present invention, and illustrates an air ejection state for removing foreign substances in the interior of the weld gun.

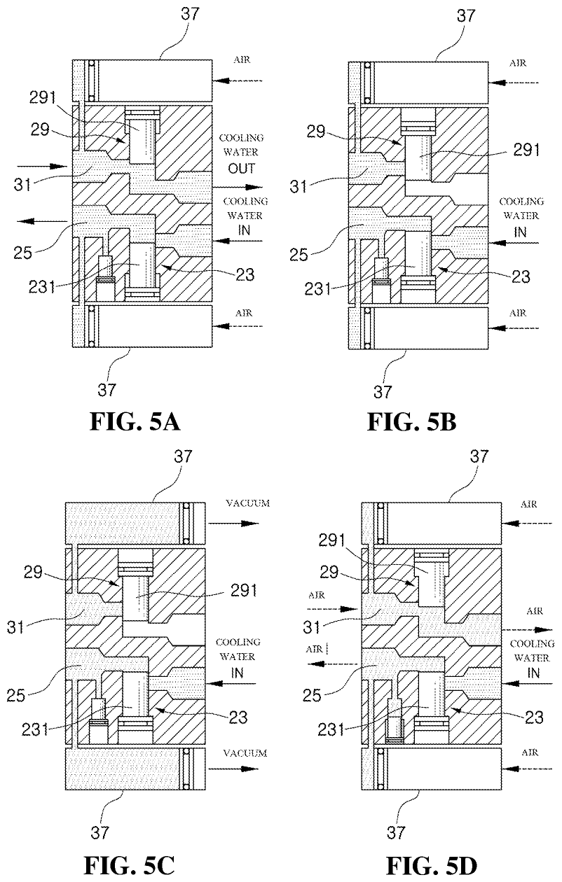

FIGS. 5A, 5B, 5C and 5D are schematic cross-sectional views of the device for blocking cooling water of the weld gun according to the embodiment of the present invention.

FIG. 6 is a diagram illustrating a cooling water supply line of a weld gun according to the related art.

* Description of Main parts of Drawings *

1: device for blocking cooling water of weld gun 3: cooling water pipeline
5: weld gun 7, 9: tip of weld gun
11: cooling water discharge pipeline 13, 19: first and second valves
15, 17, 19: first, second, and third solenoid valves
23, 29, 39, 43, 45: first, second, third, fourth, and fifth piston valves
25: main supply pipeline 27: cooling water inlet pipe
31: main discharge pipeline 33: cooling water ejection pipeline
35: suction means 37: auxiliary tank
41: vacuum unit 47: cleaning means
49: pressure sensor 51: transformer
53: manifold 55: suction pipeline

### BEST MODE

Hereinafter, details of the present invention will be described in detail with reference to the accompanying drawings. In the drawings, the direction in which cooling water is supplied is indicated by an arrow of a solid line, and a line in which a pneumatic pressure is supplied is indicated by an arrow of a dotted line.

A device 1 (hereinafter, simply referred to as ‘a blocking device’) for blocking cooling water of a weld gun according to the present invention is installed between a cooling water supply part 3 and a weld gun 5 to prevent cooling water left in the weld gun 5, a cooling water introduction hose 27, and a cooling water discharge hose 33 from flowing due to the pressure and the self-weight of the water. The cooling water is discharged through a cooling water discharge pipeline 11 after circulating the weld gun 5. The cooling water contained in a tank is supplied by using a hydraulic pump, and the discharged cooling water is recovered to the tank to be used after being cooled.

The device 1 (hereinafter, referred to as ‘the blocking device’) for blocking cooling water of the weld gun forms a predetermined fluid circuit.

A pneumatic pressure supply part 13 supplies compressed air to the blocking device 1. The blocking device 1 has three solenoid valves 15, 17, and 19 that are installed in parallel and are operated individually. The compressed air is supplied to a desired part by the solenoid valves to operate the circuit.

A first piston value 23 is supplied with cooling water from a cooling water inlet end. The first piston valve 23 is connected to a first solenoid valve 15 that is operated by a signal of a control unit to be operated according to the signal. An output end of the first piston valve 23 is connected to the main supply pipeline 25. The main supply pipeline 25 is connected to a cooling water inlet pipe 27 of the weld gun. A second piston valve 29 operated by the first solenoid valve 15 is installed on the main discharge pipeline 31 to block or pass the discharged cooling water. The main discharge pipeline 31 is connected to a cooling water ejection pipeline 33 of the weld gun.

As the first solenoid valve 15 is switched on or off, pistons 231 and 291 of the first and second piston valves are operated upwards and downward in the drawings to block introduction and discharge of the cooling water. FIGS. 1 and 5A illustrate a normal operation state in which the cooling water is supplied and discharged, and FIGS. 2 and 5B illustrate a state in which the supply and discharge of the cooling water are blocked.

Meanwhile, according to the present invention, a suction means 35 for suctioning the cooling water filled on the pipeline through vacuum and containing the cooling water when the weld gun tips 7 and 9 are removed and the pipeline is opened.

The suction means 35 is operated by the second solenoid valve 17. The suction means includes a third piston valve 39, one side of which is connected to the second solenoid valve 17 and an opposite side of which is connected to the auxiliary tank 37, and a vacuum unit 41 for generating a vacuum pressure. Further, in order to suction and contain the cooling water in the weld gun, an auxiliary tank 37 installed on the main supply pipeline 25 and the main discharge pipeline 31 is further provided. Since the auxiliary tank 37 prevents the cooling water, which is to drop, from dropping by using the vacuum pressure, it does not require a large capacity. FIGS. 3 and 5C illustrate a state in which the cooling water has been suctioned into the auxiliary tank 37 while the weld gun is opened.

Meanwhile, the third solenoid valve 19 is connected to a fourth piston valve 43 and a fifth piston valve 45 to operate the pistons 431 and 451 installed in the piston valves. The third solenoid valve 19, the fourth piston valve 43, and the fifth piston valve 45 correspond to a cleaning means 47 for cleaning the blocking device 1 and the cooling line in the interior of the weld gun.

A pressure sensor 49 is installed on the main discharge pipeline 11 of the blocking device to detect a drop of an instant pressure on the pipeline as the weld gun tips 7 and 9 are separated so as to drive the circuit. The pressure sensor 49 is adapted to detect a change in the instant pressure of the supplied fluid and may be replaced by a flow sensor or the like. FIGS. 4 and 5D illustrate a state in which cleaning is performed while air is supplied and discharged to and from the pipeline.

Reference numeral 51′ denotes a transformer, and reference numeral 53 denotes a manifold to which the blocking device 1 and the weld gun are jointed.

Hereinafter, an operation of the above-described configuration will be described.

First, a normal state will be described with reference to FIGS. 1 and 5A. The normal state refers to a state in which the weld gun performs an operation, and refers to a state in which the cooling water is supplied and discharge to and from the weld gun 5.

In this state, all the first, second, and third solenoid valves 15, 17, and 19 are switched off. Distal ends 151 and 152 of the pipelines connected to the first solenoid valve 15 pushes the pistons 231 and 291 to allow the cooling water to flow along the direction of an arrow indicated by a solid line. Since the pressure of the compressed air supplied by the first, second, and third solenoid valves 15, 17, and 19 is higher than the cooling water supply pressure, the pistons are operated as illustrated in the drawings to allow the cooling water to flows as illustrated.

In this state, the compressed air ejected from the distal ends 171 and 172 of the pipeline connected to the second solenoid valve 17 pushes the pistons 391 and 371 such that the pistons are biased to the right side in the drawings.

The cooling water supply unit 3 supplies the cooling water to the weld gun 5 through the first piston valve 23, the second piston valve 29, and the main supply pipeline 25. The cooling water that passed through the weld gun 5 is discharged to the cooling water discharge pipeline 11 though the main discharge pipeline 33.

FIGS. 2 and 5B correspond to a state in which both the supply and discharge of the cooling water are blocked by switching on only the first solenoid valve 15. Accordingly, both the first and second piston valves 23 and 29 are operated to prevent the cooling water from being introduced or discharged. This state refers to a state in which the welding operation of the weld gun is not performed, and represents a state in which the supply of the cooling water is not necessary.

FIGS. 3 and 5C illustrate a state in which the tips 7 and 9 of the weld gun are replaced due to wear or are fused to the product to be accidently separated from the weld gun 5.

In this state, the pressure of the cooling water of the cooling water pipeline decreases instantly. According to the embodiment of the present invention, in particular, the pressure sensor 49 is installed on the main discharge pipeline 31, and the pressure sensor 49 detects an instant drop of the pressure in the cooling water pipeline to allow the control unit to operate the device.

In this state, the first and second solenoid valves 15 and 17 remains switched on, and the third solenoid valve 19 remains switched off. In this case, the compressed air is supplied to several sites as indicated by an arrow.

First, as the first solenoid valve 15 is switched on, the compressed air is supplied to the distal ends 153, 154, and 155 of the pipeline, and as the piston 231 of the first piston valve is actuated upwards, the cooling water is prevented from passing through the first piston valve 23. Further, at the same time, the compressed air actuates the piston 291 of the second piston valve 29 downwards as illustrated after locating the piston 431 to the illustrated location through the distal end 154 connected to the fourth piston valve 43 and the distal end 155 of the second piston valve. Accordingly, the cooling water contained in the cooling water ejection pipeline 33 also is blocked by the second piston valve 29 and is prevented from being discharged. As a result, the cooling water is confined in the device 1 for blocking the cooling water of the weld gun and is prevented from being introduced or discharged.

In this situation, the suction unit 35 is actuated to suction the cooling water filled in the weld gun by the vacuum pressure to hold the cooling water so that the cooling water does not drop to the outside of the weld gun.

The suction means 35 includes a second solenoid valve 17, a third piston valve 39 that controls a supply path of the compressed air with the second solenoid valve 17, a vacuum unit 41 connected to the third piston valve, and an auxiliary tank 37 for holding the suctioned cooling water of a predetermined amount.

The second solenoid valve 17 pushes the piston 391 of the third piston valve 39 leftwards in the drawings to form vacuum. The vacuum unit discharges the compressed air (M) to form a negative pressure in a venturi tube 174, and the negative pressure is operated through the suction pipeline 55 to move the piston 371 of the auxiliary tank leftwards in the drawings. In this process, the cooling water contained in the main supply pipeline 25, the weld gun 5, and the main discharge pipeline 31 is suctioned into and filled in the auxiliary tank 37.

Hereinafter, the cleaning means 47 will be described with reference to FIGS. 4 and 5D.

The present invention includes a system for periodically cleaning the device 1 for blocking cooling water of the weld gun. The cleaning means 47 includes a third solenoid valve 19, fourth and fifth piston valves 43 and 45 that control the supply path of the compressed air with the third solenoid valve 19.

The cleaning means 47 is actuated by switching on the first and third solenoid valves 15 and 19 and switching off the second solenoid valve 17. The compressed air supplied to the distal end 192 extending from the fifth piston valve 45 by the third solenoid valve 19 supplies the air to the pipelines 25, 27, 33, and 31 after pushing the piston 451 of the fifth piston valve downwards. Further, the compressed air introduced to the distal end 193 extending from the fourth piston valve 43 operates the piston 431 of the fourth piston valve 43 upwards in the drawings, and allows the compressed air introduced into the second piston valve 29 to actuate the piston 291 of the second piston valve upwards in the drawings through the distal end 154 of the pipeline to open the second piston valve by using the first solenoid valve 23. Accordingly, the air can be discharged to the outside through the cooling water discharge pipeline 11.

In this state, the first solenoid valve 15 lifts the piston 231 of the first piston valve to prevent introduction of the cooling water. Further, the second solenoid valve 17 discharges the compressed air along the main supply pipeline 25, the weld gun 5, the main discharge pipeline 33, and the cooling water discharge pipeline 11 via the third piston valve 41 in an off state.

### INDUSTRIAL APPLICABILITY

Since an on/off valve and a check valve applied to an existing robot welding line is not necessary and cooling water is hardly leaked according to the present invention, the cooling water is hardly discharged when a tip is replaced by a mechanical device or by an operator. Since the device for blocking cooling water of a weld gun according to the present invention can be installed to be spaced apart from the weld gun by about 15 m, it can be easily maintained and managed.

The configurations illustrated and described above is merely a preferred embodiment based on the technical spirit of the present invention. It is noted that an ordinary person in the art to which the present invention can make various modifications based on the common technical sense but the modifications also fall within the scope of the present invention.

1. A device for blocking cooling water of a weld gun, the device being installed between a cooling water supply pipeline and the weld gun to prevent cooling water left in the weld gun from dropping when a tip of the weld gun is separated, the device comprising:
a first piston valve (23) connected to a first solenoid valve (15) operated by a signal of a control unit to be actuated by the signal, the first piston valve (23) being supplied the cooling water from a cooling water inlet end;
a main supply pipeline (23), one end of which is connected to a cooling water inlet pipe (27) and an opposite side of which is connected to an output end of the first piston valve (23);
a second piston valve (29) operated by the first solenoid valve (15), the second piston valve (29) being installed on a main discharge pipeline (31) to block or pass the discharged cooling water;
a suction means (35) for suctioning the cooling water filled on a pipeline through vacuum and holding the cooling water when the tip of the weld gun is removed and the pipeline is opened; and
a pressure sensor (49) or a flow sensor configured to detect a pressure on the pipeline from instantly dropping as the tip of the weld gun is separated to drive a circuit, thereby detecting an instant change of the pressure of a fluid.

2. The device of claim 1, wherein the suction means (35) includes:
a second solenoid valve (17) operated by a signal of the pressure sensor (49) or the flow sensor;
an auxiliary tank (37) installed on the main supply pipeline (23) and the main discharge pipeline (31) to suction the cooling water in the weld gun and hold the cooling water;
a third piston valve (39), one side of which is connected to the second solenoid valve (17) and an opposite side of which is connected to the auxiliary tank (37); and
a vacuum unit (41) that actuates the auxiliary tank (37) by selectively generating a positive pressure and a vacuum pressure by the third piston valve (39).

3. The device of claim 1, further comprising:
a cleaning means (47) for cleaning a cooling line in the interior of a welding gun,
wherein the cleaning means (47) includes:
a first solenoid valve (15) configured to block introduction and discharge of the cooling water by closing the first piston valve (23) and the second piston valve (29);
a third solenoid valve (19) operated by a control unit;
a fourth piston valve (43) operated by the third solenoid valve (19), and discharge the cooling water from the welding gun to the outside through the main discharge pipeline (31) by opening only the second piston valve (29); and
a fifth piston valve (45) operated by the third solenoid valve (19), and configured to cause air pressure to flow through the welding gun.
